(19) United States
(12) Patent Application Publication
(10) Pub. No.: US 2025/0269444 A1
(43) Pub. Date: Aug. 28, 2025

(54) Indexing System for Milling Tools

(71) Applicant: Kennametal Inc., Latrobe, PA (US)

(72) Inventors: Logan Semnisky, Latrobe, PA (US); Andreas Wuerfels, Fuerth (DE)

(73) Assignee: Kennametal Inc., Latrobe, PA (US)

(21) Appl. No.: 18/588,782

(22) Filed: Feb. 27, 2024

(51) Int. Cl. B23C 5/22

(52) U.S. Cl. CPC B23C 5/22

(57) ABSTRACT

An example indexing system has a tool body, a cam, a carrier rod, and an indexable cutting insert. The tool body is rotatable around a tool body central axis and has a bore. The cam is attached to the tool body and is rotatable around the tool body central axis between a cam first position and a cam second position. The carrier rod is partially disposed within the bore, contacts the cam, and is moveable between a carrier rod first position when the cam is in the cam first position and a carrier rod second position when the cam is in the cam second position. The indexable cutting insert is attached to the carrier rod and is moveable between a clamped position when the carrier rod is in the carrier rod first position and an indexing position when the carrier rod is in the carrier rod second position.

### FIELD

The disclosure relates generally to the field of milling tools. More particularly, the disclosure relates to an indexing system for milling tools.

### BACKGROUND

Milling tools are generally equipped with a relatively large number of indexable cutting inserts that require indexing when the cutting edges become worn. Indexing is usually performed manually such that each cutting insert is detached, indexed with an unused cutting edge arranged for active cutting, and then mounted again. Manually indexing cutting inserts is time-consuming and costly as it requires the milling tool to be taken out of operation during indexing.

Prior attempts at performing indexing operations in milling tools have incorporated, among other components, springs to move the inserts between clamped and indexing positions. However, the use of springs increases the overall cost of manufacturing a device and reduces the stiffness and clamping force used to hold an insert in place, which can lead to decreased performance and repeatability issues. In addition, using springs increases the complexity associated with assembling and maintaining the device.

A need exists, therefore, for new and useful indexing systems for milling tools.

### SUMMARY

Various example indexing systems for milling tools are described.

An example indexing system has a tool body, a cam, a carrier rod, and an indexable cutting insert. The tool body is rotatable around a tool body central axis. The tool body has a tool body central passageway, a bore, and an insert pocket having a plurality of side contact surfaces. The cam is attached to the tool body, is disposed within the tool body central passageway, and is rotatable around the tool body central axis between a cam first position and a cam second position. The carrier rod is partially disposed within the bore, contacts the cam, and is moveable between a carrier rod first position and a carrier rod second position. The carrier rod is in the carrier rod first position when the cam is in the cam first position. The carrier rod is in the carrier rod second position when the cam is in the cam second position. The indexable cutting insert is attached to the carrier rod and has an insert center axis and a plurality of side support surfaces. The indexable cutting insert is moveable between a clamped position and an indexing position. The indexable cutting insert is in the clamped position when the carrier rod is in the carrier rod first position. The indexable cutting insert is in the indexing position when the carrier rod is in the carrier rod second position. In the clamped position, a first side support surface of the plurality of side support surfaces contacts a first side contact surface of the plurality of side contact surfaces and a second side support surface of the plurality of side support surfaces contacts a second side contact surface of the plurality of side contact surfaces. In the indexing position, the first side support surface does not contact the first side contact surface, the second side support surface does not contact the second side contact surface, and the indexable cutting insert is rotatable around the insert center axis.

Additional understanding of these examples can be obtained by review of the detailed description, below, and the appended drawings.

### BRIEF DESCRIPTION OF THE DRAWINGS

FIG. 1 is a perspective view of a first embodiment of an indexing system. The indexable cutting inserts are illustrated in a clamped position.

FIG. 2 is another perspective view of the indexing system shown in FIG. 1. The indexable cutting inserts are illustrated in an indexing position.

FIG. 3 is an exploded view of the indexing system shown in FIG. 1.

FIG. 4 is a top view of the indexing system shown in FIG. 1. The indexable cutting inserts are illustrated in a clamped position.

FIG. 4A is a magnified view of area 4A shown in FIG. 4.

FIG. 5 is another top view of the indexing system shown in FIG. 1. The indexable cutting inserts are illustrated in an indexing position.

FIG. 6 is a magnified view of a first side of an indexable cutting insert shown in FIG. 1.

FIG. 7 is a magnified view of a first side of an indexable cutting insert shown in FIG. 2.

FIG. 8 is a magnified view of a second side of an indexable cutting insert shown in FIG. 1.

FIG. 9 is a magnified view of a second side of an indexable cutting insert shown in FIG. 2.

FIG. 10 is a partial perspective view of the indexing system shown in FIG. 1.

FIG. 11 is a perspective view of a carrier rod of the indexing system shown in FIG. 1.

FIG. 12 is a perspective view of a shim of the indexing system shown in FIG. 1.

FIG. 13 is a sectional view of the indexing system shown in FIG. 1.

FIG. 14 is a perspective view of a second embodiment of an indexing system. The indexable cutting inserts are illustrated in a clamped position.

FIG. 15 is a sectional view of the indexing system shown in FIG. 14.

FIG. 16 is a perspective view of a carrier rod of the indexing system shown in FIG. 14.

FIG. 17 is a perspective view of an alternative carrier rod shaft that can be included in an indexing system.

### DETAILED DESCRIPTION

The following detailed description and the appended drawings describe and illustrate various example embodiments of an indexing system. The description and illustration of these examples are provided to enable one skilled in the art to make and use an indexing system according to this invention. They are not intended to limit the scope of the claims in any manner.

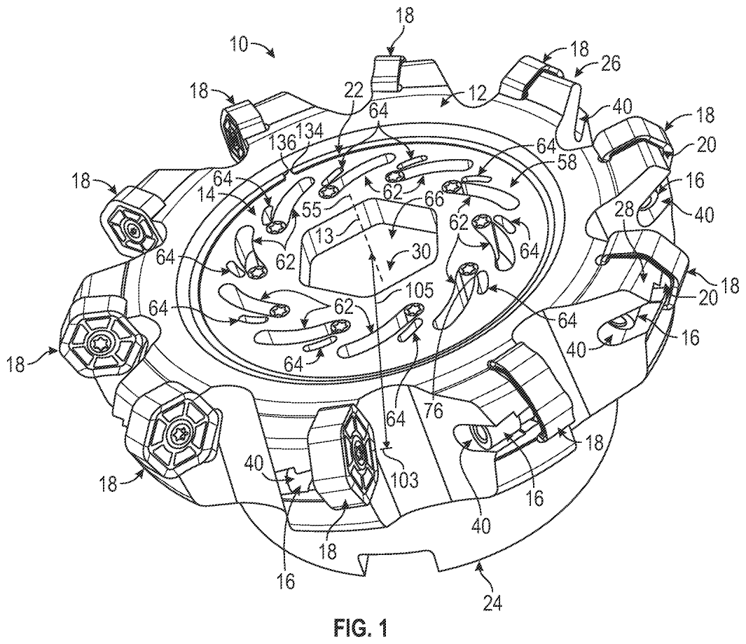

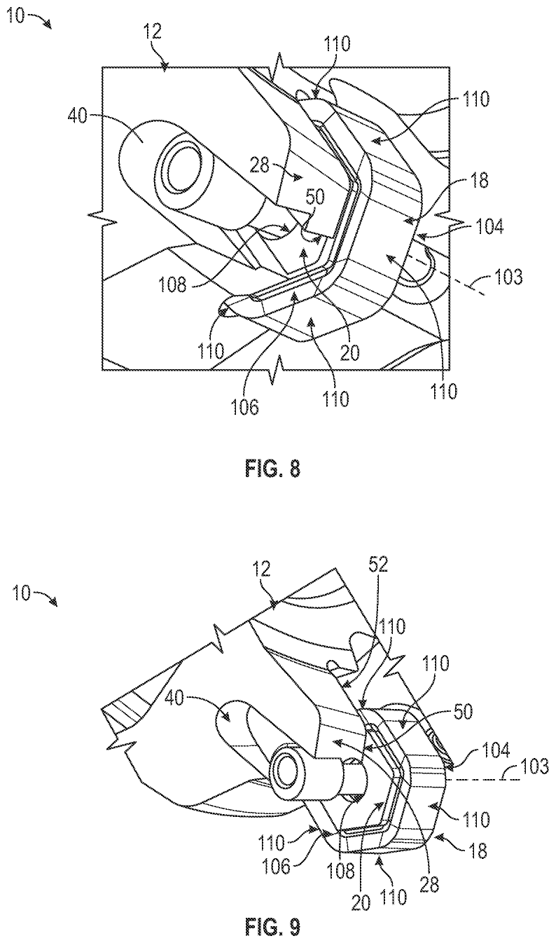

FIGS. 1 through 13 illustrate a first example indexing system 10. The indexing system 10 has a tool body 12, a cam 14, a plurality of carrier rods 16, a plurality of indexable cutting inserts 18, a plurality of shims 20, and a retaining ring 22.

As shown in FIGS. 1 through 10 and 13, the tool body 12 is rotatable around a tool body central axis 13 and has a tool body first end 24, a tool body second end 26, a tool body periphery 28, a tool body central passageway 30, a tool body recess 32, a tool body first shoulder 34, a tool body second shoulder 36, a plurality of bores 38, a plurality of slots 40, and a plurality of insert pockets 42.

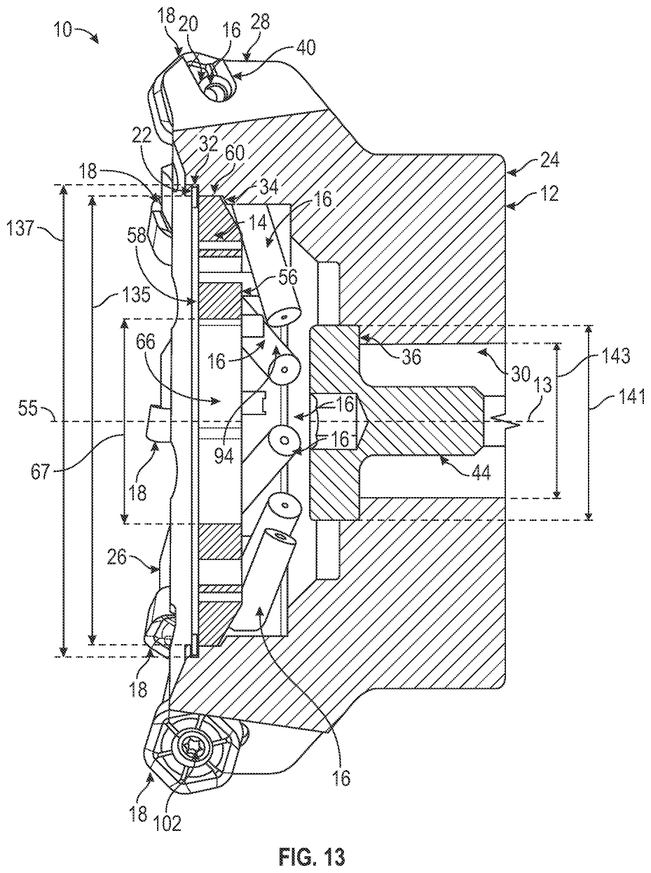

The tool body central passageway 30 extends through the tool body 12 and from the tool body first end 24 to the tool body second end 26. The tool body recess 32 extends from the tool body central passageway 30 into the tool body 12, around the tool body central axis 13, and is sized and configured to receive a portion of the retaining ring 22, as described in more detail herein. The tool body first shoulder 34 is disposed between the tool body recess 32 and the tool body second shoulder 36. The tool body first shoulder 34 provides a mechanical stop to advancement of the cam 14 during assembly. The tool body second shoulder 36 is disposed between the tool body first shoulder 34 and the tool body first end 24 and provides a mechanical stop to advancement of a locking bolt 44, as shown in FIG. 13 and described in more detail herein.

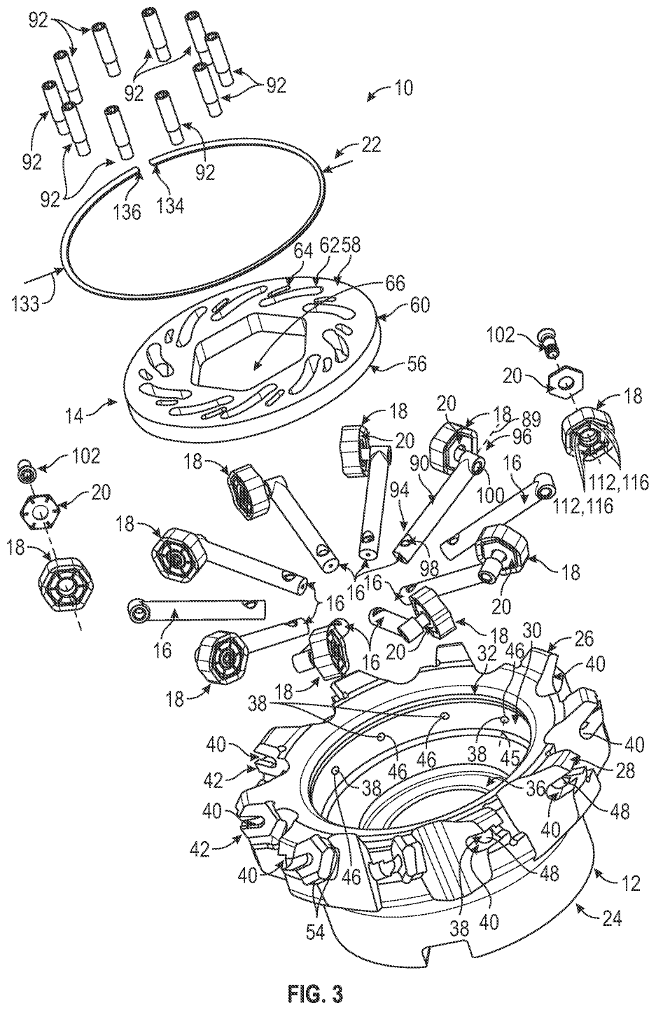

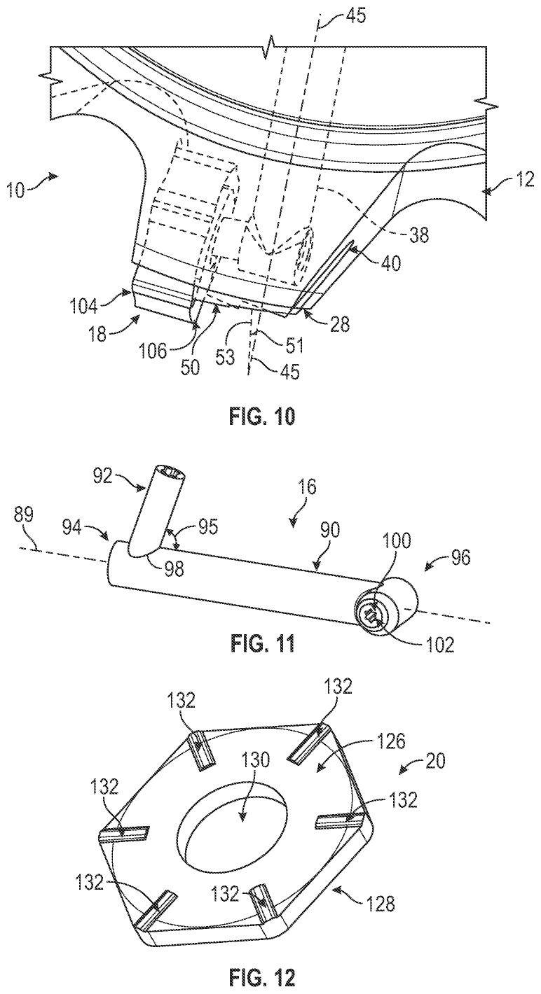

As shown in FIGS. 3 and 10, each bore of the plurality of bores 38 has a bore lengthwise axis 45, a bore first end 46, and a bore second end 48. Each bore of the plurality of bores 38 extends from a respective bore first end 46, which is disposed at the tool body central passageway 30, toward the tool body periphery 28 to a respective bore second end 48. The bore second end 48 is disposed at the slot 40. Each bore of the plurality of bores 38 extends from the bore first end 46 to the bore second end 48 and is sized and configured to receive a portion of a respective carrier rod of the plurality of carrier rods 16. Each slot of the plurality of slots 40 extends from the tool body periphery 28 toward the tool body central passageway 30 to a respective bore of the plurality of bores 38 and is sized and configured to receive a portion of a respective carrier rod of the plurality of carrier rods 16.

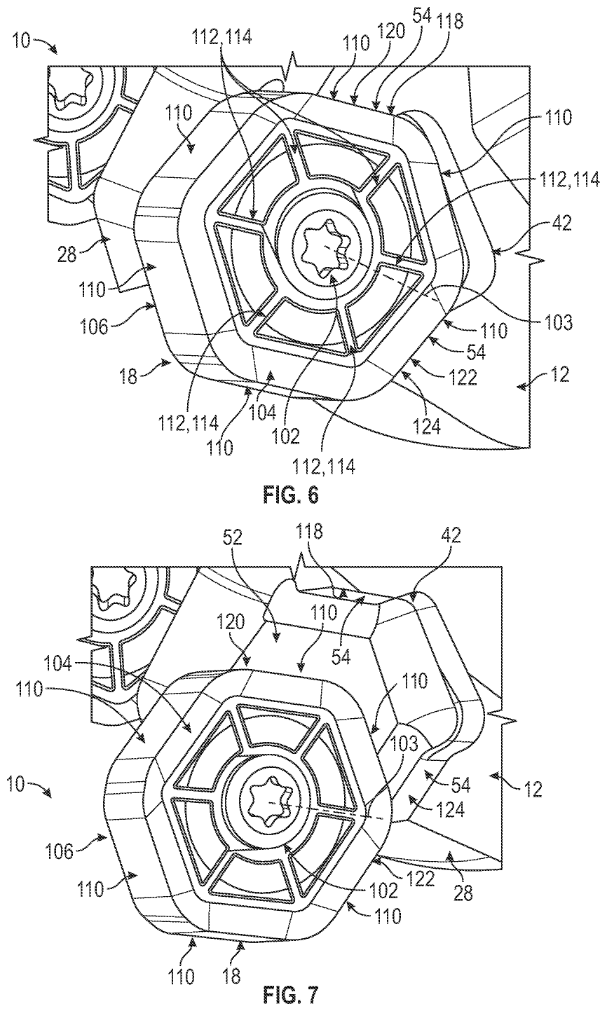

As shown in FIGS. 6, 7, 8, and 9, each insert pocket of the plurality of insert pockets 42 has an insert pocket terminal end 50, an insert pocket tangential wall 52, and a plurality of side contact surfaces 54. Each slot of the plurality of slots 40 extends from a respective insert pocket terminal end 50 toward the tool body central passageway 30 and into the insert pocket tangential wall 52. In the embodiment shown, a bore of the plurality of bores 38 extends toward a respective insert pocket tangential wall 52 from the bore first end 46 to the bore second end 48. The bore lengthwise axis 45 of each bore of the plurality of bores 38 is not parallel to a respective the insert pocket tangential wall 52. As shown in FIG. 10, the bore lengthwise axis 45 of each bore of the plurality of bores 38 is disposed at an angle 51 relative to a hypothetical plane 53 that is disposed parallel to a respective insert pocket tangential wall 52. This structural arrangement provides a mechanism for pulling an indexable cutting insert toward an insert pocket tangential wall when moving from an indexing position to a clamped position and for pushing the indexable cutting insert away from the insert pocket tangential wall when moving from a clamped position to an indexing position. In the illustrated embodiment, the angle 51 is equal to about 5 degrees. However, in alternative embodiments a bore lengthwise axis of each bore of a plurality of bores can be disposed at any suitable angle relative to a hypothetical plane that is disposed parallel to a respective insert pocket tangential wall. Examples of angles considered suitable include angles equal to, less than, greater than, or about 1 degree, 2 degrees, 3 degrees, 4 degrees, 5 degrees, 6 degrees, 7 degrees, 8 degrees, 9 degrees, 10 degrees, and any other angle considered suitable for a particular embodiment.

While the tool body 12 has been illustrated as having a particular structural arrangement and as including a tool body recess 32, a tool body first shoulder 34, a tool body second shoulder 36, a plurality of bores 38, a plurality of slots 40, and a plurality of insert pockets 42, a tool body can include any suitable structural arrangement and number of features. Selection of a suitable structural arrangement for a tool body and of a number of features to include on a tool body can be based on various considerations, including the intended use of the indexing system of which the tool body is a component. Examples of numbers of bores, slots, and insert pockets considered suitable to include on a tool body include one, at least one, two, a plurality, three, four, five, six, seven, eight, nine, ten, more than ten, and any other number considered suitable for a particular embodiment. In the illustrated embodiment, the plurality of bores 38 includes ten bores, the plurality of slots 40 includes ten slots, and the plurality of insert pockets 42 includes ten insert pockets.

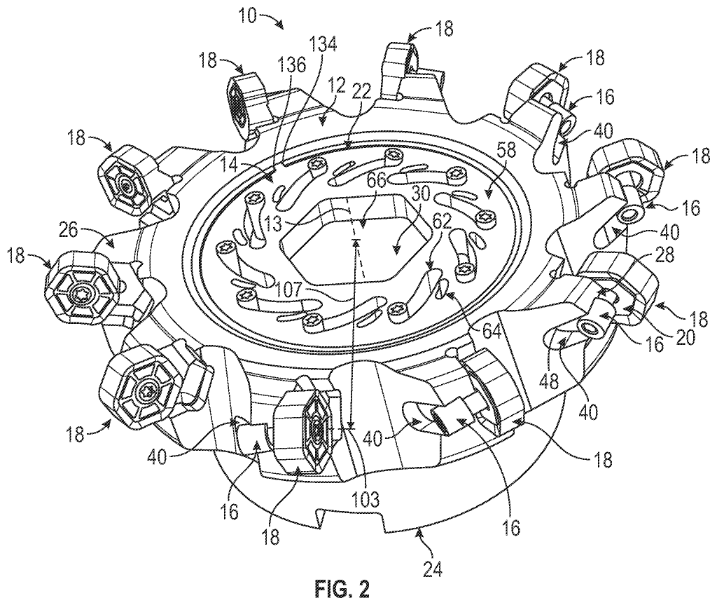

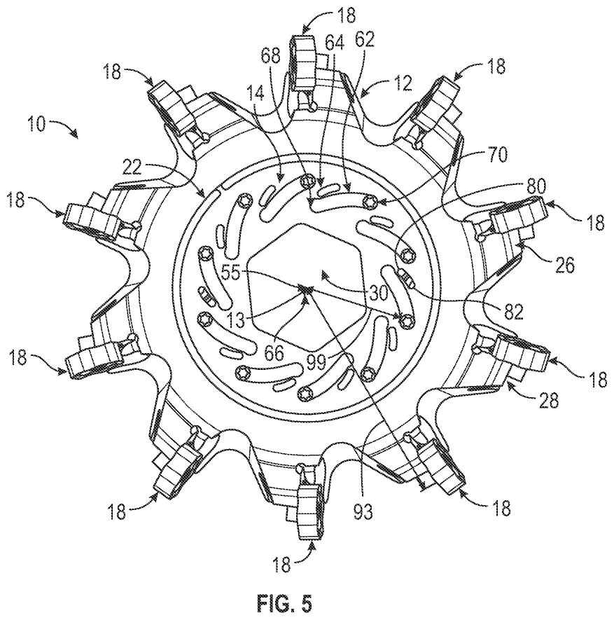

The cam 14 is attached to the tool body 12, is disposed within the tool body central passageway 30, and is rotatable around the tool body central axis 13 between a cam first position, as shown in FIGS. 1, 4, and 13, and a cam second position, as shown in FIGS. 2 and 5. In the embodiment shown, the cam 14 is releasably attached to the tool body 12 and has about 36 degrees of rotation around the tool body central axis 13, which results in complete movement of each carrier rod of the plurality of carrier rods 16 through a respective cam first slot 62, as described herein. However, alternative embodiments can include a cam that has any suitable degree of rotation around a tool body central axis, such as those greater than, or less than, 36 degrees.

In the illustrated embodiment, the cam 14 is rotatable around a cam central axis 55 and has a cam first side 56, a cam second side 58, a cam periphery 60, a plurality of cam first slots 62, a plurality of cam second slots 64, and a cam passageway 66 that extends from the cam first side 56 to the cam second side 58. In the embodiment shown, the cam central axis 55 is coaxial with the tool body central axis 13. A cam can rotate between a cam first position and a cam second position by inserting a tool within a cam passageway, such as a hexagonal tool, and rotating the cam counterclockwise and clockwise.

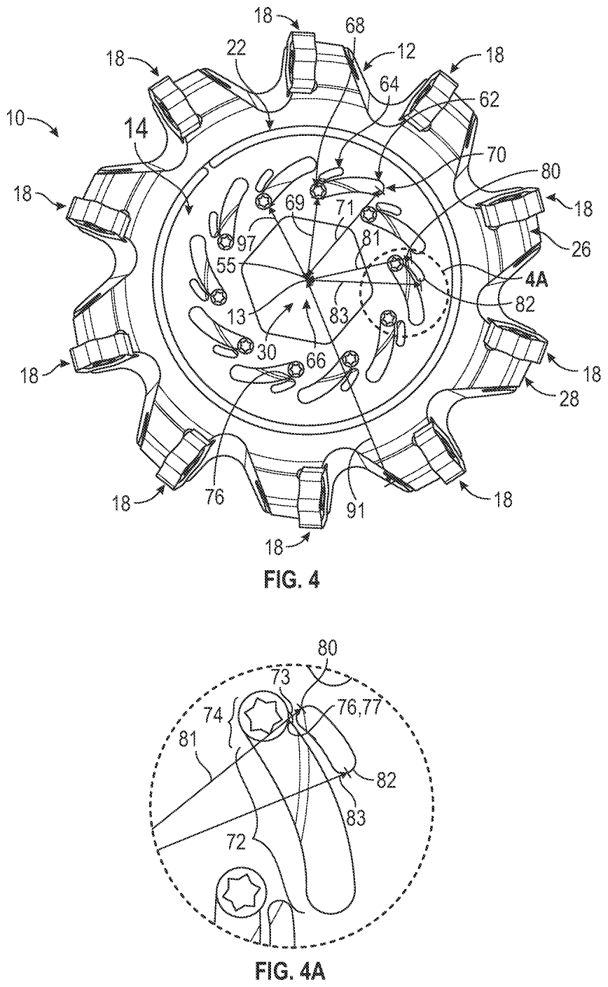

As shown in FIGS. 3 and 4, each cam first slot of the plurality of cam first slots 62 extends from the cam first side 56 to the cam second side 58 and has a cam first slot first end 68, a cam first slot second end 70, a cam first slot first portion 72, and a cam first slot second portion 74. The cam first slot first end 68 is disposed a first distance 69 from the tool body central axis 13. The cam first slot second end 70 is disposed a second distance 71 from the tool body central axis 13 that is different than the first distance 69. In the illustrated embodiment, the second distance 71 is greater than the first distance 69. As shown in FIG. 4A, the cam first slot first portion 72 is disposed at an angle 73 relative to the cam first slot second portion 74 that is less than 180 degrees. Stated otherwise, the cam first portion 72 curves in a first direction and the cam second portion 74 curves in a second different direction, that is different (e.g., opposite) than the first direction). In the illustrated embodiment, the first direction is radially inward and the second direction is radially outward. This structural arrangement defines a rollover point 76 having an apex 77 within each cam first slot of the plurality of cam first slots 62, which a respective carrier rod of the plurality of carrier rods 16 interacts with to lock the carrier rod and a respective insert of the plurality of indexable cutting inserts 18 when the cam 14 is in the cam first position. For example, as a respective carrier rod of the plurality of carrier rods 16 moves within its cam first slot of the plurality of cam first slots 62 from its carrier rod first position to its carrier rod second position, as described in more detail herein, it travels over the apex 77 and is maintained in the carrier rod second position until a force is applied to the cam 14 to move it to the carrier rod first position.

As shown in FIGS. 3 and 4, each cam second slot of the plurality of cam second slots 64 is disposed between a respective cam first slot of the plurality of cam first slots 62 and the cam periphery 60. Each cam second slot of the plurality of cam second slots 64 extends from the cam first side 56 to the cam second side 58 and has a cam second slot first end 80 and a cam second slot second end 82. The cam second slot first end 80 is disposed a first distance 81 from the tool body central axis 13. The cam second slot second end 82 is disposed a second distance 83 from the tool body central axis 13 that is different than the first distance 81. In the illustrated embodiment, the second distance 83 is greater than the first distance 81. The inclusion of a cam second slot positioned adjacent to a respective cam first slot provides flexibility to the cam first slot that can account for different tolerances between inserts, insert pockets, and other components within the system and also result in fully seating each insert against an insert pocket tangential wall.

While the cam 14 has been illustrated as having a particular structural arrangement and as including a plurality of cam first slots 62, a plurality of cam second slots 64, and a cam passageway 66, a cam can include any suitable structural arrangement and number of features. Selection of a suitable structural arrangement for a cam and of the type and number of features to include on a cam can be based on various considerations, including the intended use of the indexing system of which the cam is a component. Examples of numbers of cam first slots and cam second slots considered suitable to include on a cam include one, at least one, two, a plurality, three, four, five, six, seven, eight, nine, ten, more than ten, and any other number considered suitable for a particular embodiment. In the illustrated embodiment, the plurality of cam first slots 62 includes ten slots and the plurality of cam second slots 64 includes ten slots. Examples of suitable structural arrangements for a cam include forming a cam as a disk, bar, or tubular member. Examples of suitable structural arrangements for a cam passageway include any structural arrangement configured to receive a portion of a tool, such as those that have cross-sectional shapes that are hexagonal and can receive a hex tool, those that have square cross-sectional shapes that are square and can receive a square-head tool, and any other shape considered suitable for a particular embodiment.

Each carrier rod of the plurality of carrier rods 16 is partially disposed with a respective bore of the plurality of bores 38, is partially disposed within a respective slot of the plurality of slots 40, is partially disposed within a respective cam first slot of the plurality of cam first slots 62, and contacts the cam 14. Each carrier rod of the plurality of carrier rods 16 is moveable between a carrier rod first position, as shown in FIGS. 1, 4, 6, 8, 10, and 13, and a carrier rod second position, as shown in FIGS. 2, 5, 7, and 9. Each carrier rod of the plurality of carrier rods 16 is in the carrier rod first position when the cam 14 is in the cam first position and is in the carrier rod second position when the cam 14 is in the cam second position.

In the illustrated embodiment, and as shown in FIGS. 3 and 11, each carrier rod of the plurality of carrier rods 16 has a carrier rod lengthwise axis 89, a carrier rod shaft 90, and a carrier rod pin 92 that extends from the carrier rod shaft 90. The carrier rod shaft 90 has a shaft first end 94, a shaft second end 96, a shaft first passageway 98, and a shaft second passageway 100. The shaft first end 94 is disposed within the tool body central passageway 30. The shaft second end 96 is attached to a respective indexable cutting insert of the plurality of indexable cutting inserts 18 using an insert screw 102, as described in more detail herein. The shaft first passageway 98 is sized and configured to receive a portion of the carrier rod pin 92. The shaft second passageway 100 is sized and configured to receive a portion of an insert screw 102, as described in more detail herein.

The carrier rod shaft 90 is moveable within its respective bore of the plurality of bores 38 when the cam 14 rotates between the cam first position and the cam second position. In the illustrated embodiment, rotational movement of the cam 14 results in linear movement of the carrier rod shaft 90. As shown in FIGS. 4 and 5, the shaft second end 96 is disposed a shaft first distance 91 from the tool body central axis 13 when each carrier rod of the plurality of carrier rods 16 is in the carrier rod first position and a shaft second distance 93 from the tool body central axis 13 when each carrier rod of the plurality of carrier rods 16 is in the carrier rod second position. The shaft second distance 93 is different than the shaft first distance 91. In the illustrated embodiment, the shaft second distance 93 is greater than the shaft first distance 91.

The carrier rod pin 92 is disposed within the shaft first passageway 98 and at an angle 95 relative to the carrier rod shaft 90 that is less than 90 degrees. In the illustrated embodiment, the carrier rod pin 92 is releasably attached to the carrier rod shaft 90 using a threaded connection. However, in alternative embodiments a carrier rod pin can be permanently attached to a carrier rod shaft or attached using other techniques or methods of attachment. Furthermore, in alternative embodiments a carrier rod pin can be disposed at any suitable angle relative to a carrier rod shaft, such as those that are greater than, less than, or equal to 90 degrees. The carrier rod pin 92 of each carrier rod of the plurality of carrier rods 16 is disposed within a respective cam first slot of the plurality of cam first slots 62 and is moveable within its respective cam first slot when the cam 14 rotates between the cam first position and the cam second position. As shown in FIGS. 4 and 5, the carrier rod pin 92 of each carrier rod of the plurality of carrier rods 16 is disposed a pin first distance 97 from the tool body central axis 13 when each carrier rod of the plurality of carrier rods 16 is in the carrier rod first position and a pin second distance 99 from the tool body central axis 13 when each carrier rod of the plurality of carrier rods 16 is in the carrier rod second position. The pin second distance 99 is different than the pin first distance 97. In the illustrated embodiment, the pin second distance 99 is greater than the pin first distance 97.

While a plurality of carrier rods 16 has been illustrated as being included in the indexing system 10 and each carrier rod of the plurality of carrier rods 16 has been illustrated as having a particular structural arrangement, an indexing system can include any suitable number of carrier rods having any suitable structural arrangement. Selection of a suitable structural arrangement for a carrier rod and of a suitable number of carrier rods to include in an indexing system can be based on various considerations, including the intended use of the indexing system of which a carrier rod is a component. Examples of numbers of carrier rods considered suitable to include in an indexing system include one, at least one, two, a plurality, three, four, five, six, seven, eight, nine, ten, more than ten, and any other number considered suitable for a particular embodiment. In the illustrated embodiment, the plurality of carrier rods 16 includes ten carrier rods.

Each indexable cutting insert of the plurality of indexable cutting inserts 18 is attached to a respective carrier rod of the plurality of carrier rods 16 using an insert screw 102 and is moveable between a clamped position, as shown in FIGS. 1, 4, 6, 8, 10, and 13, and an indexing position, as shown in FIGS. 2, 5, 7, and 9. While an insert screw 102 has been illustrated as attaching a indexable cutting insert to a carrier rod any suitable technique or method of attachment can be utilized to accomplish attachment between an indexable cutting insert and a carrier rod.

Each indexable cutting insert of the plurality of indexable cutting inserts 18 is in the clamped position when a respective carrier rod of the plurality of carrier rods 16 is in the carrier rod first position and the cam 14 is in the cam first position. Each indexable cutting insert of the plurality of indexable cutting inserts 18 is in the indexing position when a respective carrier rod of the plurality of carrier rods 16 is in the carrier rod second position and the cam 14 is in the cam second position. Each indexable cutting insert of the plurality of indexable cutting inserts 18 contacts an insert pocket tangential wall 52 of a respective insert pocket of the plurality of insert pockets 42 in the clamped position. Each indexable cutting insert of the plurality of indexable cutting inserts 18 does not contact an insert pocket tangential wall 52 of a respective insert pocket of the plurality of insert pockets 42 in the indexing position.

As shown in FIGS. 6, 7, 8, and 9, each indexable cutting insert of the plurality of indexable cutting inserts 18 is a double-sided insert and has an insert center axis 103, an insert first side 104, an insert second side 106, an insert passageway 108, a plurality of side support surfaces 110, and a plurality of insert recesses 112. The insert passageway 108 extends from the insert first side 104 to the insert second side 106 and is sized and configured to receive the insert screw 102 to accomplish attachment of an indexable cutting insert of the plurality of indexable cutting inserts 18 to a respective carrier rod of the plurality of carrier rods 16. An insert screw can have any suitable structural arrangement to accomplish attachment between an insert and a carrier rod. For example, an insert screw can have a threaded portion along its shaft that has an outside diameter that is less than the inside diameter of an insert passageway. Alternatively, an insert screw can have a shaft that is partially threaded to allow for attachment to a carrier rod and rotation of an insert on the insert screw along the unthreaded portion. The plurality of side support surfaces 110 is disposed around the insert center axis 103 and is arranged to be supported by the plurality of side contact surfaces 54 of the tool body 12. A first set of recesses 114 of the plurality of insert recesses 112 extends from the insert first side 104 toward the insert second side 106. Each recess in the first set of recesses 114 is sized and configured to receive a projection of the plurality of projections 132 of a shim of the plurality of shims 20. A second set of recesses 116 of the plurality of insert recesses 112 extends from the insert second side 106 toward the insert first side 104. Each recess in the second set of recesses 116 is sized and configured to receive a projection of the plurality of projections 132 of a shim of the plurality of shims 20. Alternative embodiments can omit a plurality of recesses and define other structure to accomplish a mating arrangement between an indexable cutting insert and a shim. For example, an insert can comprise a single sided positive insert or a double sided negative insert with no shim.

Each indexable cutting insert of the plurality of indexable cutting inserts 18 is rotatable around a respective insert center axis 103 and is free to turn in both a clockwise direction and counterclockwise direction around the insert center axis 103 when in the indexing position. In the embodiment shown, each indexable cutting insert of the plurality of indexable cutting inserts 18 is hexagonal and has a rotational symmetry around the insert center axis 103. However, in alternative embodiments, an indexable cutting insert included in an indexing system can have any suitable number of side support surfaces, cutting surfaces, and have any suitable shape.

As shown in FIGS. 1 and 2, the insert center axis 103 of each indexable cutting insert of the plurality of indexable cutting inserts 18 is disposed an insert first distance 105 from the tool body central axis 13 when in the clamped position and an insert second distance 107 from the tool body central axis 13 when in the indexing position. The insert second distance 107 is different than the insert first distance 105. In the illustrated embodiment, the insert second distance 107 is greater than the insert first distance 105. As shown in FIG. 7, each indexable cutting insert of the plurality of indexable cutting inserts 18 is disposed about 7 mm from a first side contact surface 118 of the plurality of side contact surfaces 54 when in the indexing position. In the clamped position, as shown in FIG. 6, a first side support surface 120 of the plurality of side support surfaces 110 contacts a first side contact surface 118 of the plurality of side contact surfaces 54 and a second side support surface 122 of the plurality of side support surfaces 110 contacts a second side contact surface 124 of the plurality of side contact surfaces 54. In the indexing position, as shown in FIG. 7, the first side support surface 120 of the plurality of side support surfaces 110 does not contact the first side contact surface 118 of the plurality of side contact surfaces 54 and the second side support surface 122 of the plurality of side support surfaces 110 does not contact the second side contact surface 124 of the plurality of side contact surfaces 54.

While a plurality of indexable cutting inserts 18 has been illustrated as being included in the indexing system 10 and each indexable cutting insert of the plurality of indexable cutting inserts 18 has been illustrated as having a particular structural arrangement, an indexing system can include any suitable number of indexable cutting inserts having any suitable structural arrangement. Selection of a suitable structural arrangement for an indexable cutting insert and of a suitable number of indexable cutting inserts to include in an indexing system can be based on various considerations, including the intended use of the indexing system of which an indexable cutting inserts is a component. Examples of numbers of indexable cutting inserts considered suitable to include in an indexing system include one, at least one, two, a plurality, three, four, five, six, seven, eight, nine, ten, more than ten, and any other number considered suitable for a particular embodiment. In the illustrated embodiment, the plurality of indexable cutting inserts 18 includes ten cutting inserts. Furthermore, while each indexable cutting insert of the plurality of indexable cutting inserts 18 has been illustrated as disposed about 7 mm from a first side contact surface 118 of the plurality of side contact surfaces 54 when in the indexing position, an indexable cutting insert can be disposed any suitable distance relative to a first side contact surface when in an indexing position. For example, the linear distance an indexable cutting insert is disposed from a first side contact surface when in the indexing position is dependent upon the size of the indexable cutting insert and/or the geometry of an insert pocket.

Each shim of the plurality of shims 20 is disposed between a respective indexable cutting insert of the plurality of indexable cutting inserts 18 and the tool body 12. As shown in FIG. 12, each shim of the plurality of shims 20 has a shim first side 126, a shim second side 128, a shim passageway 130, and a plurality of shim projections 132. The shim passageway 130 extends from the shim first side 126 to the shim second side 128 and is sized and configured to receive a portion of the insert screw 102 to accomplish attachment of a shim to a carrier rod of the plurality of carrier rods 16. Each projection of the plurality of shim projections 132 extends from the shim first side 126 and away from the shim second side 128 and is sized and configured to be received by a respective recess of the plurality of insert recesses 112. The mating configuration between a shim of the plurality of shims 20 and a respective indexable cutting insert of the plurality of indexable cutting inserts 18 provides a mechanism for preventing a positive cutting edge of an indexable cutting insert from catching on the insert pocket tangential wall 52 when the indexable cutting insert is moved between a clamped position and an indexing position. Alternative embodiments, however, can omit a plurality of projections and define other structure to accomplish a mating configuration between a shim and an indexable cutting insert.

While a plurality of shims 20 has been illustrated as being included in the indexing system 10 and each shim of the plurality of shims 20 has been illustrated as having a particular structural arrangement, an indexing system can include any suitable number of shims having any suitable structural arrangement. Selection of a suitable structural arrangement for a shim and of a suitable number of shims to include in an indexing system can be based on various considerations, including the intended use of the indexing system of which a shim is a component. Examples of numbers of shims considered suitable to include in an indexing system include one, at least one, two, a plurality, three, four, five, six, seven, eight, nine, ten, more than ten, and any other number considered suitable for a particular embodiment. In the illustrated embodiment, the plurality of shims 20 includes ten shims.

The retaining ring 22 is disposed within the tool body recess 32 and releasably attaches the cam 14 to the tool body 12. As shown in FIGS. 1 and 3, the retaining ring 22 has a retaining ring first end 134, a retaining ring second end 136, and is moveable between a first configuration and a second configuration. In the first configuration, the retaining ring 22 has a first outside diameter 133 that is less than the inside diameter 135 of the tool body central passageway 30 at the tool body recess 32. In the second configuration, as shown in FIG. 13, the retaining ring 22 has a second outside diameter 137 that is greater than the inside diameter 135 of the tool body central passageway 30 at the tool body recess 32.

As shown in FIG. 13, in an example embodiment, the indexing system 10 can be attached to a shell mill adapter, or other component, using a locking bolt 44. The locking bolt 44 has a locking bolt outside diameter 141 that is less than the inside diameter 67 of the cam passageway 66 and greater than the smallest inside diameter 143 of the tool body central passageway 30. To position the locking bolt 44, the locking bolt 44 is passed through the cam passageway 66 and into the tool body central passageway 30. Subsequently, the locking bolt 44 is attached to a shell mill adapter or other component (e.g., using a threaded connection). The structural arrangement of the indexing system 10 allows for attachment of the indexing system 10 to a shell mill adaptor or other component without having to disassemble the indexing system 10. A tool, such as a hex tool, can then be positioned within the cam passageway 66 and rotated clockwise or counterclockwise to move the cam 14 between the cam first position and the cam second position. The indexing systems described herein provide for increased productivity as a result of all indexable cutting inserts being indexable simultaneously and without removal from a tool body.

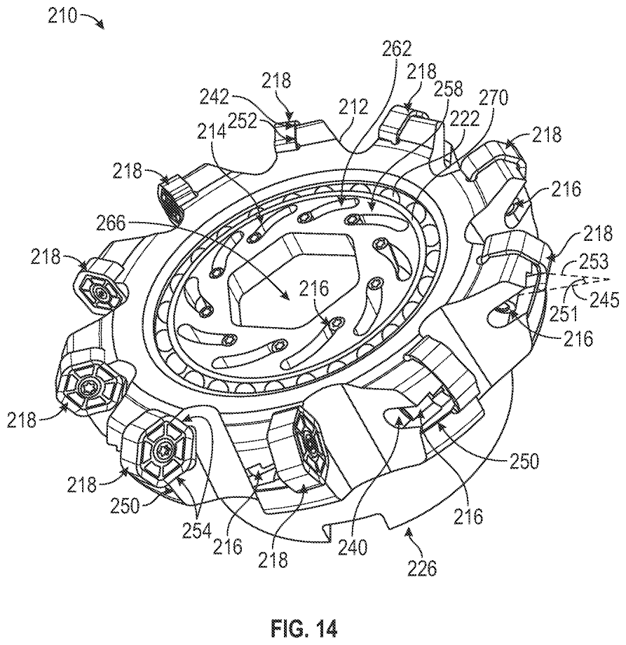

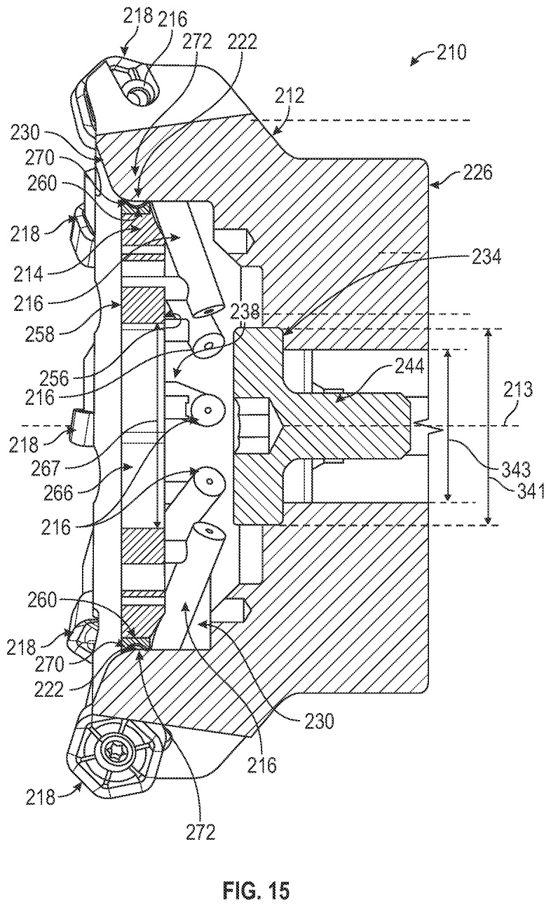

FIGS. 14 and 15 illustrate a second example indexing system 210. The indexing system 210 has a tool body 212, a cam 214, a plurality of carrier rods 216, a plurality of indexable cutting inserts 218, and a plurality of ball bearings 222. In the embodiment shown, each indexable cutting insert of the plurality of indexable cutting inserts 218 are single-sided inserts, which do not require a shim.

In the illustrated embodiment, the tool body first shoulder 234 is disposed between the tool body first end 224 and the tool body second end 226 and provides a mechanical stop to advancement of a locking bolt 244, as shown in FIG. 15 and described in more detail herein. The cam 214 is attached to the tool body 212, is disposed within the tool body central passageway 230, and is rotatable around the tool body central axis 213. In the illustrated embodiment, the cam 214 has a cam first side 256, a cam second side 258, a cam periphery 260, a plurality of cam first slots 262, and a cam passageway 266 that extends from the cam first side 256 to the cam second side 258.

Each insert pocket of the plurality of insert pockets 242 has an insert pocket terminal end 250, an insert pocket tangential wall 252, and a plurality of side contact surfaces 254. In the embodiment shown, the bore lengthwise axis 245 of each bore of the plurality of bores 238 is disposed at an angle 251 relative to a hypothetical plane 253 that is disposed parallel to a respective insert pocket tangential wall 252 of an insert pocket of the plurality of insert pockets 242. In the illustrated embodiment, the angle 251 is less than 5 degrees.

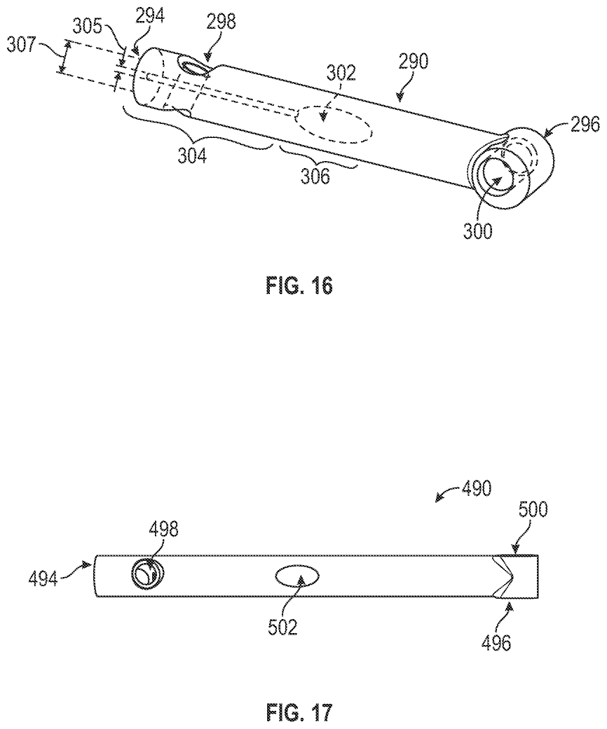

Each carrier rod of the plurality of carrier rods 216 is partially disposed with a respective bore of the plurality of bores 238, is partially disposed within a respective slot of the plurality of slots 240, is partially disposed within a respective cam first slot of the plurality of cam first slots 262, and contacts the cam 214. In the embodiment shown, and as shown in FIG. 16, each carrier rod shaft 290 has a shaft first end 294, a shaft second end 296, a shaft first passageway 298, a shaft second passageway 300, and a chamber 302.

The chamber 302 extends from the shaft first end 294, toward the shaft second end 296, and has a chamber first portion 304 and a chamber second portion 306. The chamber first portion 304 extends from the shaft first end 294, toward the shaft second end 296, through the shaft first passageway 298, and has a first inside diameter 305. The chamber second portion 306 extends from the chamber first portion 304, toward the shaft second end 296, and has a second inside diameter 307 that is greater than the first inside diameter 305. In the embodiment shown, the chamber first portion 304 is elongated, the chamber second portion 306 is bulbous (e.g., revolved elliptical shape), and the carrier rod shaft 290 is manufactured using 3D printing. However, alternative embodiments can include a chamber having any suitable structural arrangement and can include a carrier rod shaft manufactured using any suitable method or technique to achieve a reduction of the stiffness in the system. The inclusion of a chamber 302 reduces stiffness relative to carrier rods that omit a chamber and allows a shaft to account for differences in tolerances between insert pockets. A carrier rod, such as a carrier rod of the plurality of carrier rods 216, can be used as an alternative to the inclusion of a cam second slot or in combination with the inclusion of a cam second slot depending on the stiffness needed in a system.

The plurality of ball bearings 222 is disposed within the tool body central passageway 230 and between the tool body 212 and the cam 214. The plurality of ball bearings 222 are disposed between an inner race 270 and an outer race 272. The structural arrangement between the tool body 212, the cam 214, the inner race 270, the outer race 727, and the plurality of ball bearings 222 provide a mechanism for both attaching the cam 214 to the tool body 212 and allowing for rotational movement of the cam 214 relative to a tool body 212 during use. An example assembly includes pressing the cam 214 into the inner race 270 and then pressing the outer race 272 into the tool body passageway 230. Alternatively, an inner race can be defined by a cam periphery and an outer race can be defined by a tool body.

As shown in FIG. 15, in an example embodiment, the indexing system 210 can be attached to a shell mill adapter, or other component, using a locking bolt 244. The locking bolt 244 has an outside diameter 341 that is less than the inside diameter 267 of the cam passageway 266 and greater than the smallest inside diameter 343 of the tool body central passageway 230. To position the locking bolt 244, the cam 214 does not need to be removed from the tool body 212. Rather, the locking bolt 244 is passed through the cam passageway 266, contacts the tool body first shoulder 234, and is attached to a shell mill adapter or other component (e.g., using a threaded connection). The indexing system 210 is then ready to be used.

FIG. 17 illustrates an alternative carrier rod shaft 490 that can be included in an indexing system. The carrier rod shaft 490 has a shaft first end 494, a shaft second end 496, a shaft first passageway 498, a shaft second passageway 500, and a shaft third passageway 502. The shaft third passageway 502 is disposed between the shaft first passageway 498 and the shaft second passageway 500 and has an elliptical cross-sectional shape. However, in alternative embodiments, a shaft third passageway can have any suitable shape. The inclusion of a shaft third passageway 502 reduces stiffness relative to carrier rods that omit a third passageway and allows a shaft to account for differences in tolerances between insert pockets.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. An indexing system comprising:
a tool body rotatable around a tool body central axis, the tool body having a tool body central passageway, a bore, and an insert pocket having a plurality of side contact surfaces;
a cam attached to the tool body, disposed within the tool body central passageway, and rotatable around the tool body central axis between a cam first position and a cam second position;
a carrier rod partially disposed within the bore, contacting the cam, and moveable between a carrier rod first position and a carrier rod second position, the carrier rod is in the carrier rod first position when the cam is in the cam first position, the carrier rod is in the carrier rod second position when the cam is in the cam second position; and
an indexable cutting insert attached to the carrier rod, the indexable cutting insert having an insert center axis and a plurality of side support surfaces, the indexable cutting insert moveable between a clamped position and an indexing position, the indexable cutting insert is in the clamped position when the carrier rod is in the carrier rod first position, the indexable cutting insert is in the indexing position when the carrier rod is in the carrier rod second position, in the clamped position a first side support surface of the plurality of side support surfaces contacts a first side contact surface of the plurality of side contact surfaces and a second side support surface of the plurality of side support surfaces contacts a second side contact surface of the plurality of side contact surfaces, in the indexing position the first side support surface does not contact the first side contact surface, the second side support surface does not contact the second side contact surface, and the indexable cutting insert is rotatable around the insert center axis.

2. The indexing system of claim 1, wherein the cam has a cam first slot, the cam first slot having a cam first slot first end and a cam first slot second end, the cam first slot first end disposed a first distance from the tool body central axis, the cam first slot second end disposed a second distance from the tool body central axis that is different than the first distance; and
wherein the carrier rod is disposed within the cam first slot.

3. The indexing system of claim 2, wherein the second distance is greater than the first distance.

4. The indexing system of claim 2, wherein the carrier rod has a carrier rod shaft and a carrier rod pin extending from the carrier rod shaft, the carrier rod pin disposed within the cam first slot, the carrier rod pin disposed a pin first distance from the tool body central axis when the carrier rod is in the carrier rod first position and a pin second distance from the tool body central axis when the carrier rod is in the carrier rod second position, the pin second distance being different than the pin first distance.

5. The indexing system of claim 4, wherein the pin second distance is greater than the pin first distance.

6. The indexing system of claim 4, wherein the carrier rod pin moves within the cam first slot when the cam rotates between the cam first position and the cam second position.

7. The indexing system of claim 4, wherein the carrier rod pin is releasably attached to the carrier rod shaft.

8. The indexing system of claim 2, wherein the cam first slot has a cam first slot first portion and a cam first slot second portion, the cam first slot first portion curving in a first direction and the cam first slot second portion curving in a second, different direction such that a rollover point having an apex is defined within the cam first slot.

9. The indexing system of claim 2, wherein the cam has a cam periphery and a cam second slot disposed between the cam first slot and the cam periphery.

10. The indexing system of claim 1, wherein the insert pocket has an insert pocket terminal end and an insert pocket tangential wall;
wherein the tool body has a slot extending from the insert pocket terminal end toward the tool body central passageway and into the insert pocket tangential wall; and
wherein the carrier rod is partially disposed within the slot.

11. The indexing system of claim 10, wherein the bore extends from a bore first end disposed at the tool body central passageway to a bore second end disposed at the slot.

12. The indexing system of claim 1, wherein the insert pocket has an insert pocket tangential wall; and
wherein the bore has a bore lengthwise axis that is not parallel to the insert pocket tangential wall.

13. The indexing system of claim 1, wherein the tool body has a tool body periphery;
wherein the bore extends from a bore first end disposed at the tool body central passageway toward the tool body periphery to a bore second end;
wherein the insert pocket has an insert pocket tangential wall; and
wherein the bore extends toward the insert pocket tangential wall from the bore first end to the bore second end.

14. The indexing system of claim 13, wherein the bore has a bore lengthwise axis disposed at an angle of about 5 degrees relative to a hypothetical plane that is parallel to the insert pocket tangential wall.

15. The indexing system of claim 1, wherein the cam has about 36 degrees of rotation around the tool body central axis.

16. The indexing system of claim 1, further comprising a shim disposed between the indexable cutting insert and the tool body.

17. The indexing system of claim 1, wherein the insert pocket has an insert pocket tangential wall;
wherein the indexable cutting insert contacts the insert pocket tangential wall in the clamped position; and
wherein the indexable cutting insert does not contact the insert pocket tangential wall in the indexing position.

18. The indexing system of claim 1, wherein the insert center axis is disposed an insert first distance from the tool body central axis when the indexable cutting insert is in the clamped position and an insert second distance from the tool body central axis when the indexable cutting insert is in the indexing position, the insert second distance being different than the insert first distance.

19. An indexing system comprising:
a tool body rotatable around a tool body central axis, the tool body having a tool body central passageway, a bore, and an insert pocket having a plurality of side contact surfaces and an insert pocket tangential wall, the bore having a bore lengthwise axis that is not parallel to the insert pocket tangential wall;
a cam attached to the tool body, disposed within the tool body central passageway, and rotatable around the tool body central axis between a cam first position and a cam second position, the cam having a cam first slot, the cam first slot having a cam first slot first end and a cam first slot second end, the cam first slot first end disposed a first distance from the tool body central axis, the cam first slot second end disposed a second distance from the tool body central axis that is different than the first distance;
a carrier rod partially disposed within the bore, disposed within the cam first slot, and moveable between a carrier rod first position and a carrier rod second position, the carrier rod is in the carrier rod first position when the cam is in the cam first position, the carrier rod is in the carrier rod second position when the cam is in the cam second position; and
an indexable cutting insert attached to the carrier rod, the indexable cutting insert having an insert center axis and a plurality of side support surfaces, the indexable cutting insert moveable between a clamped position and an indexing position, the indexable cutting insert is in the clamped position when the carrier rod is in the carrier rod first position, the indexable cutting insert is in the indexing position when the carrier rod is in the carrier rod second position, in the clamped position a first side support surface of the plurality of side support surfaces contacts a first side contact surface of the plurality of side contact surfaces and a second side support surface of the plurality of side support surfaces contacts a second side contact surface of the plurality of side contact surfaces, in the indexing position the first side support surface does not contact the first side contact surface, the second side support surface does not contact the second side contact surface, and the indexable cutting insert is rotatable around the insert center axis.

20. An indexing system comprising:
a tool body rotatable around a tool body central axis, the tool body having a tool body central passageway, a bore, and an insert pocket having a plurality of side contact surfaces and an insert pocket tangential wall, the bore having a bore lengthwise axis that is not parallel to the insert pocket tangential wall;
a cam attached to the tool body, disposed within the tool body central passageway, and rotatable around the tool body central axis between a cam first position and a cam second position, the cam having a cam periphery, a cam first slot, and a cam second slot, the cam first slot having a cam first slot first end and a cam first slot second end, the cam first slot first end disposed a first distance from the tool body central axis, the cam first slot second end disposed a second distance from the tool body central axis that is greater than the first distance, the cam second slot disposed between the cam first slot and the cam periphery;
a carrier rod partially disposed within the bore, disposed within the cam first slot, and moveable between a carrier rod first position and a carrier rod second position, the carrier rod is in the carrier rod first position when the cam is in the cam first position, the carrier rod is in the carrier rod second position when the cam is in the cam second position; and
an indexable cutting insert attached to the carrier rod, the indexable cutting insert having an insert center axis and a plurality of side support surfaces, the indexable cutting insert moveable between a clamped position and an indexing position, the indexable cutting insert is in the clamped position when the carrier rod is in the carrier rod first position, the indexable cutting insert is in the indexing position when the carrier rod is in the carrier rod second position, in the clamped position a first side support surface of the plurality of side support surfaces contacts a first side contact surface of the plurality of side contact surfaces and a second side support surface of the plurality of side support surfaces contacts a second side contact surface of the plurality of side contact surfaces, in the indexing position the first side support surface does not contact the first side contact surface, the second side support surface does not contact the second side contact surface, and the indexable cutting insert is rotatable around the insert center axis.
